(19) United States
(12) Patent Application Publication
(10) Pub. No.: US 2014/0015323 A1
(43) Pub. Date: Jan. 16, 2014

(54) Power Management System

(71) Applicant: Arista Power, Inc., Rochester, NY (US)

(72) Inventor: Mark Matthews, Fairport, NY (US)

(21) Appl. No.: 13/937,356

(22) Filed: Jul. 9, 2013

Related U.S. Application Data
(60) Provisional application No. 61/669,821, filed on Jul. 10, 2012.

(51) Int. Cl. H02J 4/00

(52) U.S. Cl. CPC H02J 4/00
USPC 307/52

(57) ABSTRACT

A system to energy being used from the electric grid as well as being used and generated from one or more energy generators or fuel-powered turbines, including, but not limited to, natural gas generators, fuel cells, diesel generators, bio-diesel generators, ethanol generators, propane generators, biogas generators and kerosene generators, or a combination of any or all of these sources, with or without a battery energy storage system, resulting in (a) a reduction of the peak power demand from the electric grid of a user of the system, and/or (b) a reduction of the high consumption charges during times in which consumption costs are higher due to variable billing or otherwise, and/or (c) the ability to provide energy to the user of the system at a time that such user is offsetting, in whole or in part, a reduction of its demand from the electric grid to, among other things, quality for, participate in and/or satisfy the requirements of demand response or similar programs with third parties.

### CROSS-REFERENCE TO RELATED APPLICATIONS

This application claims priority from U.S. Provisional Patent Application 61/669,821, filed Jul. 10, 2012, the contents of which are hereby incorporated by reference in their entirety.

### FIELD AND BACKGROUND OF THE INVENTION

The present disclosure relates to a power management system and, more particularly, to a system to manage energy being used from the electric grid as well as being used and generated from one or more energy generators or fuel-powered turbines, including, but not limited to, natural gas generators, fuel cells, diesel generators, bio-diesel generators, ethanol generators, propane generators, biogas generators and kerosene generators, or a combination of any or all of these sources, with or without a battery energy storage system, resulting in (a) a reduction of the peak power demand from the electric grid of a user of the system, and/or (b) a reduction of the high consumption charges during times in which consumption costs are higher due to variable billing or otherwise, and/or (c) the ability to provide energy to the user of the system at a time that such user is offsetting, in whole or in part, a reduction of its demand from the electric grid to, among other things, qualify for, participate in and/or satisfy the requirements of demand response or similar programs with third parties.

The power management system may or may not be integrated with a battery energy storage system. If the power management system integrates a battery energy storage system, the system will charge and discharge the battery energy storage system in a manner described in patent application Ser. No. 13/359,643 and is to be considered fully incorporated by reference. The one or more energy generators or fuel-powered turbines of the power management system may be directly connected to the battery energy storage system, the battery energy storage system may be connected only to the grid or a combination thereof.

Many electricity suppliers typically but not always utility companies, throughout much of the United States and abroad charge their commercial customers not only for the consumption of electricity but also a demand, or distribution, charge. The calculation of this demand charge varies from supplier to supplier, but is generally based upon the highest amount of power demand that a customer uses from the electric gird in a billing cycle—often called peak demand. Recently, demand charges have become an increasing part of commercial customers' electricity costs. Certain electricity suppliers have begun to charge residential customers demand charges, and that charge is expected to be implemented by additional electricity suppliers to residential customers.

Additionally, unrelated to demand charges, electricity suppliers often charge a higher rate for the consumption of electricity for commercial and residential customers during certain times of day when overall demand on the electricity supplier is greater, which is often but not always during the early afternoon hours.

In addition, many electricity suppliers compensate customers to agree in advance to lower their electrical usage if requested to do so by the electricity supplier. These programs are often called demand response programs. Typically, but not always, the electricity provider requests that the customer lower its usage at times when overall demand on the electricity supplier is unusually or unexpectedly high or to provide ancillary services to the utility such as frequency regulation or synchronous reserve. The amount compensated to customers by the electricity suppliers could be annually, quarterly, weekly, daily or otherwise, or any combination thereof. Typically, but not always, the amount compensated to the customer is based, in whole or in part, upon the amount of energy that the customer agrees to cease using for a period of time upon request by the electricity provider demand response aggregator or other third party. The amount of notice provided by the electricity provider to the customer that a reduction of energy taken from the grid by such customer is required varies, but typically is between twenty-four hours and two hours. The duration that the customer is required to reduce its energy taken from the grid varies, but is typically between one and six hours.

It is commonly known to those skilled in the art when to use energy, whether generated by one or more generators, the electric grid, other sources, released from a battery energy storage system or any combination thereof, to receive improved consideration for such energy, or to reduce energy costs by reducing demand charges, by reducing consumption charges or by participating in demand response programs.

### SUMMARY AND OBJECTS OF THE INVENTION

Systems and methods for managing a power system are described. The power management system is made of several components that enable an end user of energy at the local level to use electricity from (1) the electric grid, (2) one or more energy generators or fuel-powered turbines, including, but not limited to, natural gas generators, fuel cells, diesel generators, bio-diesel generators, ethanol generators, propane generators, biogas generators and kerosene generators, or (3) a combination of any or all of these sources. In addition, the power management system may or may not be integrated with a battery energy storage system.

The power management system determines whether to draw power from the following and, if power is being drawn from more than one the following, in what amount from each, (a) the grid, (b) the energy generator(s), (c) the battery energy storage system, if integrated into the power management system, or (d) a combination thereof, depending upon the following:
(a) when the electricity demand reaches peak levels, or when the power management system expects the electricity demand to reach peak levels, the power management system sends a signal to turn on the generator(s) and/or release energy from the battery energy storage system, and energy taken from the generator(s) and/or the battery energy storage system supplements or replaces, in whole or in part, the energy from the grid in order to reduce the end user's power demand from the electric grid;
(b) when the cost to consume electricity is high, or when the power management system expects the cost to consume electricity to be high, the power management system sends a signal to turn on the generator(s) and/or release energy from the battery energy storage system, and energy taken from the generator(s) and/or the battery energy storage system supplements or replaces, in whole or in part, the energy from the grid in order to reduce consumption charges; and
(c) when the customer has been notified, directly or indirectly, including without limitation through a third party, that such customer's electricity taken from the grid must be reduced to comply with or participate in a demand response program, the power management system sends a signal to turn on the generator(s) and/or release energy from the battery energy storage system, and energy taken from the generator(s) and/or the battery energy storage system supplements or replaces the energy from the grid in a manner to comply with or participate in such demand response program.

An end user of energy at the local level would include, but is not limited to, a commercial building, a group of commercial buildings, a residential building, a group of residential buildings, a single or a group of apartment buildings, a farm or group of farms, a commercial factory, a government building or any other individual or group of free-standing structures that are connected to the electric grid.

According to some embodiments, the end user's peaks of electricity demand from the electric grid will be reduced by using energy from the generator(s) and/or the battery energy storage system when the end user's electricity demand from the electric grid is, or is expected to be, at its greatest. By reducing its highest demand, or peek demand, from the electric grid over a period of time, typically a billing cycle from the electricity provider, the end user can receive cost savings from the utility company via a reduction of its demand charges, distribution charges or other similar charges, fees or taxes that are often charged by utility companies. In addition or alternatively, an end user can receive cost savings by using energy from a generator(s) and/or the battery energy storage system instead of energy from the electric grid when the consumption charges are relatively high. In addition or alternately, according to some embodiments, an end user can successfully participate in and/or comply with demand response programs, and receive and/or keep the associated payments, as a result of energy from the generator(s) and/or the battery energy storage system offsetting some or all of the reduction of energy taken from the grid as required by the demand response program.

### BRIEF DESCRIPTION OF THE DRAWINGS

The invention is herein described, by way of example only, with reference to the accompanying drawings. With specific reference now the drawings in detail, it is stressed that the particulars shown are by way of example and for purpose of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. The accompanying drawings do not include an integrated battery energy storage system.

FIG. 1 is a schematic representation of the present invention.

FIG. 2 is a flow chart of the present invention when the discharge from the energy generator(s) is set at one or more previously determined time range(s).

FIG. 3 is a flow chart of the present invention when the discharge from the energy generator(s) occurs when the end user's power load taken from the electric grid is in excess of a previously determined threshold and the discharge from the energy generator(s) must last at least a minimum amount of time.

In describing the preferred embodiments of the invention which are illustrated in the drawings and otherwise, specific terminology will be resorted to for the sake of clarity. However, it is not intended that the invention be limited to the specific terms so selected and it is understood that each specific term includes all technical equivalents which operate in a similar manner to accomplish a similar purpose.

### DESCRIPTION OF THE PREFERRED EMBODIMENTS

Embodiments of the disclosed subject matter relate to systems methods software and devices for managing a power system. In the power management system, energy generated through one or more energy generator(s) and/or fuel-powered turbine(s) is used by the end user of the system or released into the electric grid in order to reduce the electricity bill of the end user at times when (1) the end user's power loads taken from the electric grid are relatively high, or expected to be relatively high; and/or (2) consumption charges are relatively high, or expected to be relatively high; and/or (3) the customer has been notified, directly or indirectly, including, without limitation, through a third party, that such customer's electricity taken from the grid must be reduced to comply with or participate in a demand response program.

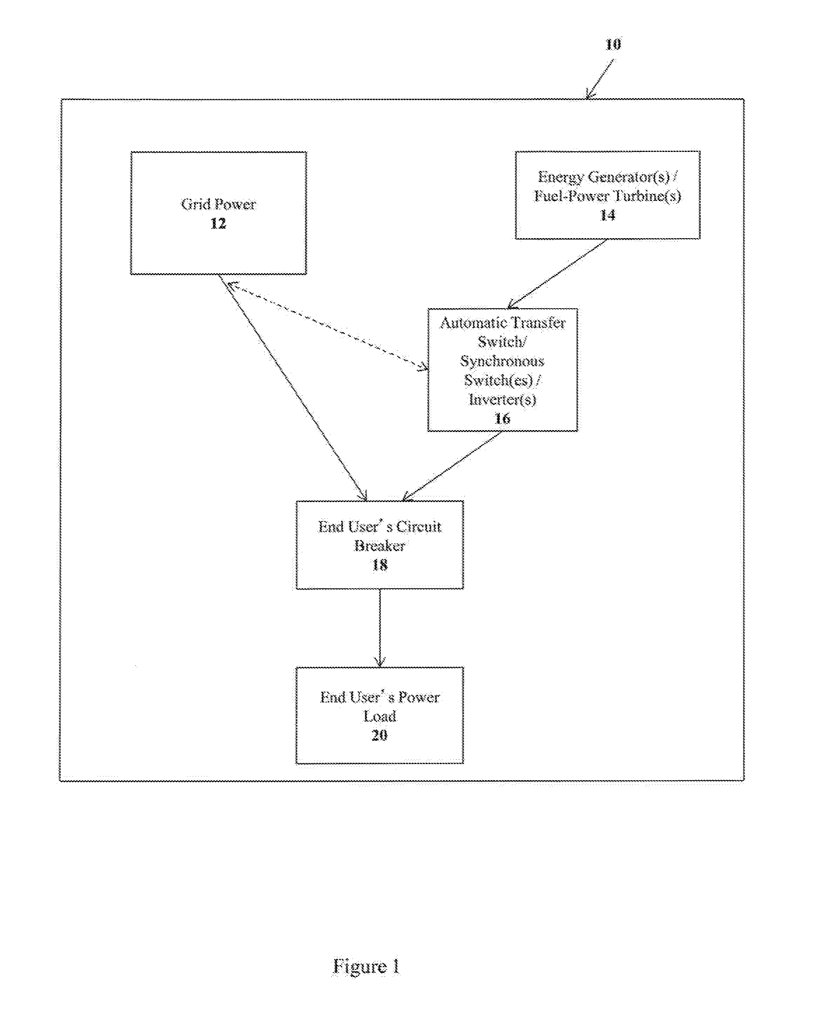

The principles and operation of a power management system according to the embodiments may be better understood with reference to the drawings (FIGS. 1, 2 and 3) and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Referring now to the drawings, FIG. 1 is a schematic representation of some embodiments of the disclosure. The exemplary method described is not intended to be limiting in any form or manner, and a person skilled in the art may appreciate that variations are possible in the implementation of the systems and methods.

The power management system 10 determines when to utilize the generator(s) by:
(a) using the energy generator(s) and/or fuel-powered turbine(s) 14 at previously designated times and/or durations,
(b) monitoring the end user's current power load 20 taken from the electric grid 12 in or close to real-time, and using the energy generator(s) and/or fuel-powered turbine(s) 14 if the end user's current power load 16 taken from the electric grid 12 is greater than or equal to previously determined threshold levels;
(c) monitoring the end user's current power load 20 taken from the electric grid 12 in or close to real-time, and using the energy generator(s) and/or fuel-powered turbine(s) 14 if the end user's current power load 20 taken from the electric grid 12 is greater than or equal to the amount determined by the power management system 10 to be a threshold point for reducing the end user's power load 20 taken from the electric grid 12 and/or consumption charges; or
(d) any combination of the above.

The power output generated by the energy generator(s) and/or fuel-powered turbine(s) 14 can vary. The power management system 10 determines the rate of power that the energy generator(s) and/or fuel-powered turbine(s) 14 are to generate by:
(a) generating at previously designated amounts of energy at previously determined power rates;
(b) monitoring the end user's current power load 20 taken from the electric grid 12 in or close to real-time and generating only such amounts of energy as would be necessary to lower the end user's power load 20 taken from the electric grid 12 to an amount that is less than or equal to previously designated levels;
(c) monitoring the end user's current power load 20 taken from the electric grid 12 in or close to real-time and generating only such amounts of energy as would be necessary to lower the end user's power load 20 taken from the electric grid 12 to an amount that is a little less than or equal to the appropriate amount of power load to be taken from the electric grid 12 as determined by the power management system 10; or
(d) any combination of the above.

The power management system 10 may combine any or all of the manners in which it determines when to generate energy from the energy generator(s) and/or fuel-powered turbine(s) 14 with any or all of the manners in which it determines how much energy to generate by the energy generator(s) and/or fuel-powered turbine(s) 14.

### Overall System Diagram Description

The power management system 10 generates power from one or more energy generators and/or fuel-powered turbines 14 when the end user's power load 20 that is taken from the grid power 12 is higher than set or calculated values, or expected to be higher than such values, or at previously determined times. Among the advantages of this timed release may be (a) a reduction in the end user's power load 20 that is taken from the grid power 12, (b) an offset of the more expensive consumption charges of the end user, typically during peak usage times, and/or (c) the ability to reduce the end user's power load 20 that is taken from the grid power 12 in order to quality has for, or satisfy the obligations of, demand response programs.

### Energy Generator(s) and/or Fuel-Powered Turbine(s)

The power management system 10 utilizes energy that is generated from the electric grid 12 and/or one or more energy generators and/or fuel-powered turbines 14. The power management system 10 utilizes the energy created by the energy generators and/or fuel-powered turbines 14 to work with the grid power 12 to fulfill the end user's power load 20

The energy created by the energy generators and/or fuel-powered turbines 14 is created in the form of DC power and then may be inverted to AC power by the applicable inverter(s) 16 and may be:
(a) combined with energy taken from the grid 12 to partially or fully fulfill the end user's power load 20 after passing through the end user's circuit breaker 18;
(b) supplied to the grid 12 through a bi-directional meter or other manner after passing through the end user's circuit breaker 18; or
(c) any combination of the above.

### End User's Circuit Breaker

The end user's circuit breaker 18 is the central point where at least one of energy sources 12, 14 in the power management system 10 are brought together when being used to fulfill the end user's power load 20

### End User's Power Load

The end user's power load 20 uses the power (kW) and energy (kWh) that are being supplied by the power management system 10 from grid power 12 and energy generators and/or fuel-powered turbines 14. In certain cases, the power management system 10 will monitor the end user's power load 20 taken from the grid 12 to determine when to utilize the energy created by the energy generators and/or fuel-powered turbines 14 and, in certain instances, at what rate such stored energy is created.

### Automatic Transfer Switch/Synchronous Switch(es)/Inverter(s)

The automatic transfer switch/synchronous switch(es)/inverter(s) 16 monitors, receives and analyzes data from the grid 12 and from the energy generators and/or fuel-powered turbines 14 to determine when to (1) synchronize energy created by the energy generators and/or fuel-powered turbines 14 with grid power 12 and/or (2) reduce the amount of energy taken from the grid 12 as a result of the energy being generated by the energy generators and/or fuel-powered turbines 14.

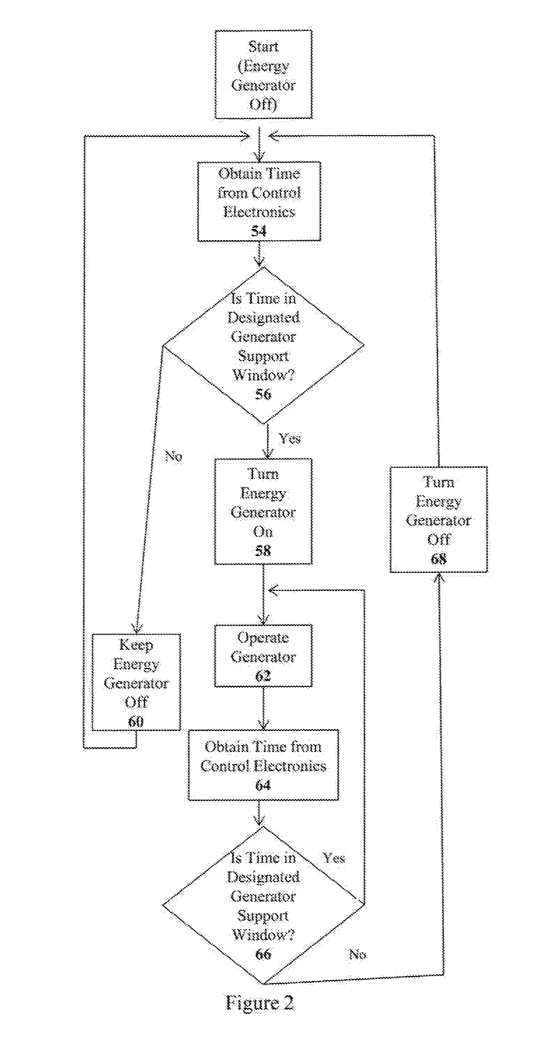

FIG. 2 provides a flow chart of some embodiments of the disclosure when the use of the energy created by the energy generators and/or fuel-powered turbines 14 is set at one previously determined time range.

The power management system 10 begins its cycle, which is typically 24 hours long but can be of any duration, with its energy generator(s) and/or fuel-powered turbine(s) 14 turned off or in standby mode, which means no significant amount of energy is being generated by the energy generator(s) and/or fuel-powered turbine(s) 14 for the end user.

In step 54 the power management system 10 obtains the time of day from its control electronics to determine in step 56 whether the time of day is within the range of times of day in which the power management system 10 directs the energy generator(s) and/or fuel-powered turbine(s) 14 to generate energy. If in step 56 the time of day is not within the range of times in which the energy generator(s) and/or fuel-powered turbine(s) 14 is directed to generate energy, the energy generator(s) and/or fuel-powered turbine(s) 14 may be turned off in step 60, if not already off, and the power management system 10 returns to obtain the time of day in step 54, and continues such a cycle of steps 56, 60 and 54 until the time of day is within the range of times in which the energy generator(s) and/or fuel-powered turbine(s) 14 is directed to generate energy.

If in step 56 the time of day is within the range of times in which the energy generator(s) and/or fuel-powered turbine(s) 14 is previously determined to generate energy, in step 58 the energy generator(s) and/or fuel-powered turbine(s) 14 are turned on and operated in step 62, and the automatic transfer switch/synchronous switch(es)/inverter(s) 16 is directed to use the energy generated from the energy generator(s) and/or fuel-powered turbine(s) 14 at a previously determined duration and rate of use. After the energy generation in step 58 has begun based on the previously determined parameters, the power management system 10 then evaluates in step 66 whether to continued to direct energy to be generated from the energy generator(s) 62 and/or fuel-powered turbine(s) 14 by obtaining the time of day from the control electronics 64 to determine whether the time of day is within the range of times of day in which the power management system 10 directs the automatic transfer switch/synchronous switch(es)/inverter(s) 16 to continue to generate energy from the energy generator(s) and/or fuel-powered turbine(s) 14.

If in step 66 the use the energy generated from the energy generator(s) and/or fuel-powered turbine(s) 14 is determined not completed, the power management system 10 repeats steps 62, 64, and will continue to repeat this cycle of steps 62, 64 and 66 until the energy generator(s) and/or fuel-powered turbine(s) 14 are no longer directed to use energy.

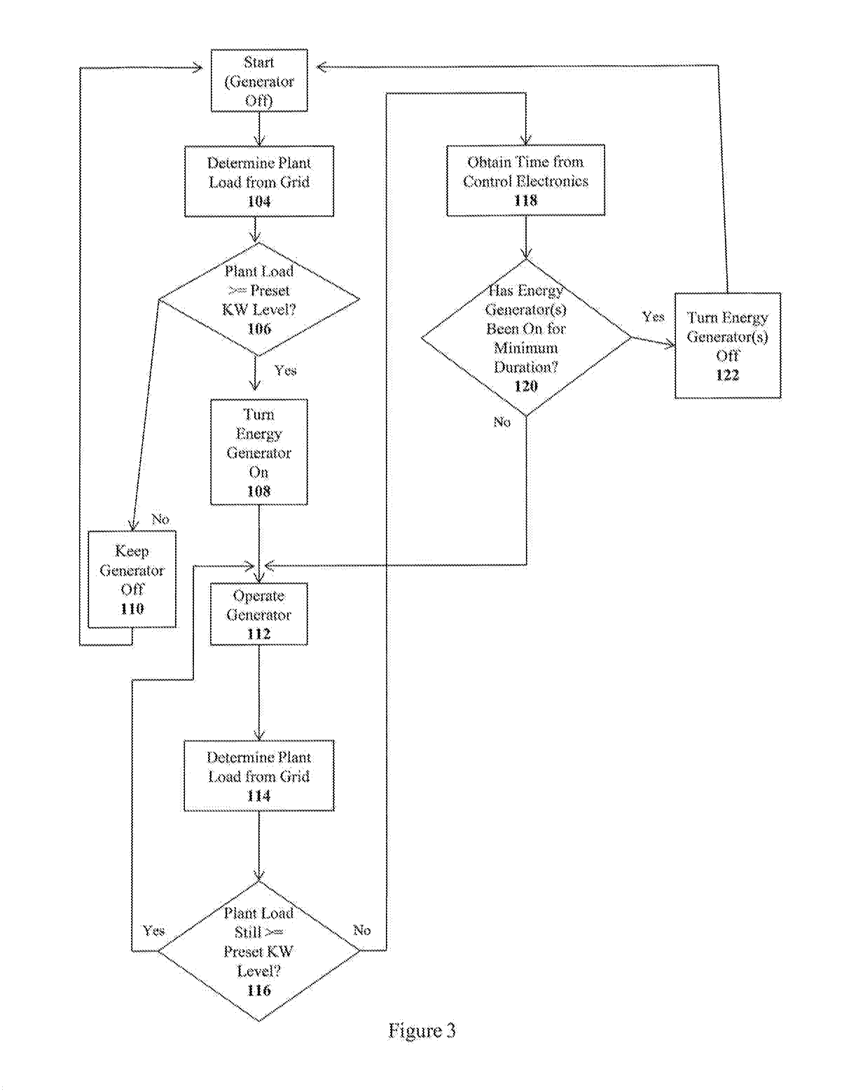

FIG. 3 is a chart of embodiments when the use of the energy generated from the energy generator(s) and/or fuel-powered turbine(s) 14 occurs when the end user's power load 20 taken from the electric grid 12 is in excess of a previously determined threshold and the amount of energy generated by the energy generator(s) and/or fuel-powered turbine(s) 14 is set at one previously determined amount.

The power management system 10 begins its cycle, which generally consists of 24 hours but can be of any duration, with its energy generator(s) and/or fuel-powered turbine(s) 14 turned off or in standby mode. In step 104, the power management system 10 determines in real-time or close to real-time the end user power load 20 taken from the electric grid 12, which is determined by (a) taking such reading from the end user's circuit breaker 18, (b) subtracting from grid power all amounts of other energy being contributed to the end user's power load 20, (c) as otherwise determined by the power management system 10, or (d) any combination of the foregoing.

If in step 106 the end user's power load 16 taken from the electric grid 12 is not at or in excess the previously determined threshold at which the energy generator(s) and/or fuel-powered turbine(s) 14 is directed to create energy, the energy generator(s) and/or fuel-powered turbine(s) 14 is turned off in step 110, if it is not already in such mode, and the power management system 10 returns to step 104 to determine if the plant load from the grid is greater than or equal to preset levels.

If in step 106 the end user power load 20 taken from the electric grid 12 is at or in excess the previously determined threshold at which the energy generator(s) and/or fuel-powered turbine(s) 14 is directed to create energy, in step 108 and 112, the automatic transfer switch/synchronous switch(es)/inverter(s) 16 is directed to use energy from the energy generator(s) and/or fuel-powered turbine(s) 14 at a previously determined amount of energy creation.

If in step 116 the end user power load 20 taken from the electric grid 12 remains at or in excess the previously determined threshold at which the energy generator(s) and/or fuel-powered turbine(s) 14 is directed to create energy, then the power management system 10 repeats step 112, and will continue to repeat this cycle of steps 112, 114 and 116 until it is determined in step 116 that the end user's power load 20 taken from the electric grid 12 is no longer at or in excess the previously determined threshold at which the energy generator(s) and/or fuel-powered turbine(s) 14 is directed to create energy.

If in step 116 the end user's power load 20 taken from the electric grid 12 is no longer at or in excess the previously determined threshold at which the energy generator(s) and/or fuel-powered turbine(s) 14 is directed to create energy, the power management system 10 in step 120 determines if the energy generator(s) and/or fuel-powered turbine(s) 14 have created energy for more than the previously determined minimum amount of time for such energy generator(s) and/or fuel-powered turbine(s) 14 to create energy. If in step 120 it is determined that the energy generator(s) and/or fuel-powered turbine(s) 14 have created energy for more than the previously determined maximum amount of time, then the energy generator(s) and/or fuel-powered turbine(s) 14 are turned off and the power management system 10 returns to step 104 to determine if the plant load from the grid is greater than or equal to preset levels. If in step 120 it is determined that the energy generator(s) and/or fuel-powered turbine(s) 14 have not created energy for more than the previously determined minimum amount of time, then the power management system 10 returns to steps 112, 114 and 116 and, if applicable, step 120 in order to create energy for more than the previously determined minimum amount of time.

It should be understood that the disclosure described above to the details of construction and arrangement of the components set forth herein. The invention is capable of other embodiments and of being practiced or carried out in various ways. Variations, alternations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

What is claimed:

1. A power management system for reducing peak demand on the electric grid having one or more energy generators or fuel-powered turbines, including, but not limed to, natural gas generators, fuel cells, diesel generators, bio-diesel generators, ethanol generators, propane generators, biogas generators and kerosene generators, or a combination of any or all of these sources with or without a battery energy storage system, comprising
a generator;
an automatic transfer switch
a circuit breaker;
a battery energy storage system inverter/charger; and
a energy inverter and/or rectifier, wherein
said circuit breaker is connected to said electric grid and at least one of said generator, energy inverter and rectifier, said battery energy storage system inverter/charger and said power load,
said energy generator being also connected to said at least one onsite connected energy source,
said generator with or without battery energy storage system inverter/charger being connected to said at least one onsite connected energy source and to said generator with or without battery energy storage system and via said circuit breaker to the power load,
wherein said system is configured to
provide power to said power load and/or to said grid from said least one onsite connected energy source and/or said generator with or without battery energy storage system,
wherein said system is configured to (a) reduce peak power demand, and/or (b) reduce consumption charges during times in which consumption costs are higher due to variable billing or otherwise, and/or (c) provide energy to the user of the system at a time that such user is offsetting, in whole or in part, a reduction of the demand from the electric grid to, among other things, quality for, participate in and/or satisfy the requirements of demand response or similar programs with third parties, by performing at least one of the following steps if a battery energy storage system is integrated into the power management system:
(a) Charging the battery energy storage system at predetermined times;
(b) Monitoring the power load taken from the electric grid and, when such power load is detected to fall below a predetermined level, charging the battery energy storage system;
(c) Monitoring the power load taken from the electric grid and, when such power load is below the appropriate level as determined by the power management system, charging the battery energy storage system; and
(d) Monitoring the remaining capacity level of the battery energy storage system and, when the remaining capacity of the battery energy storage system drops below a predetermined level or an appropriate level as determined by the power management system, charging the battery energy storage system.

2. A power management system according to claim 1, wherein said system is configured to release/discharge energy and/or power from the generator with or without battery energy storage system by performing at least one of the following steps:
(a) discharging the battery energy storage system and/or placing some or all of the load on the generator(s) at previously designated times and/or durations,
(b) monitoring the current power load taken from the electric grid, and discharging the battery energy storage system and/or placing some or all of the load on the generator(s), if the current power load taken from the electric grid is greater than or equal to predetermined threshold levels, and
(c) monitoring the current power load taken from the electric grid, and discharging the battery energy storage system and/or placing some or all of the load on the generator(s), if the current power load taken from the electric grid is greater than or equal to the amount determined by the power management system to be a threshold point for reducing the power load taken from the electric grid.

3. A power management system according to claim 1, wherein said system is configured to determine the amount of energy to be discharged from the battery energy storage system and/or generator(s) at the correct power rate by performing at least one of the following steps:
(a) discharging the battery energy storage system and/or placing some or all of the load on the generator(s) at previously designated times amounts of energy at predetermined power rates;
(b) discharging the battery energy storage system and/or placing some or all of the load on the generator(s) with an amount of energy calculated by monitoring the current power load taken from the electric grid and discharging/providing only such amounts of energy release from the battery energy storage system and/or generated by the generator(s) as would be necessary to lower the power load taken from the electric grid to an amount that is a little less than or equal to previously designated levels; and
(c) discharging the battery energy storage system and/or placing some or all of the load on the generator(s) with an amount of energy calculated by monitoring the end user's current power load taken from the electric grid and discharging and/or providing only such amounts of energy stored in the battery energy storage system and/or generated by the generator(s) as would be necessary to lower the power load taken from the electric grid to an amount that is a little less than or equal to the appropriate amount of power load to be taken from the electric grid as determined by the power management system.

4. A power management system according to claim 1, wherein said power management system is configured to distribute the energy generated by said at least one onsite connected energy source in accordance with the following hierarchy:
(a) first, energy generated by the at least one onsite connected energy source is used to supplement or replace grid power to meet the current power loads;
(b) second, if the energy generated by said at least one onsite connected energy source exceeds the current power load, any excess power generated by said at least one onsite connected energy source will be used to charge the battery energy storage system if such a battery energy storage system is integrated with the power management system; and
(c) third, if the energy generated by said at least one onsite connected energy source exceeds the current power load and the battery energy storage system, if integrated with the power management system, has no additional capacity to store additional energy at that time, the energy will be supplied to support the facility load.

6. A power management system according to claim 1, wherein said power management system is configured to use grid power to partially or fully fulfil the requirement of power load after passing through the circuit breaker.

7. A power management system according to claim 1, wherein said charging the generator comprises charging the battery energy storage system with one of:
(a) predetermined amounts of energy;
(b) such amounts of energy necessary to charge the battery energy storage system to a predetermined capacity level, i.e., between 80% to 100% full; and
(c) such amount of energy necessary to charge the battery energy storage system to an appropriate level as determined by the power management system.

8. A power management system according to claim 1, wherein each said monitoring is performed in or close to real-time.

9. A power management system according to claim 1, wherein said power management system is connected
to said electric grid,
to said at least one onsite connected energy source,
to said generator with or without battery energy storage system and
to said power load.

10. Method according to claim 9, wherein
obtaining the time of day,
determining whether said obtained time of day is within a range of times of day to discharge energy from the battery energy storage system, if integrated into the power management system, and/or generating power from the generator(s),
if it is determined that said obtained time of day is not within said range of times in which the generator(s) with or without a battery energy storage system is directed to not discharge energy from the battery energy storage system, if integrated into the power management system, and/or generating power from the generator(s), and instead putting said generator(s) with or without a battery energy storage system inverter/charger is into standby mode, and,
returning to said obtaining the time and the following steps,
if it is determined that said obtained time of day is within said range of times as which the generator(s) with or without battery energy storage system is directed to discharge energy from the battery energy storage system, if integrated into the power management system, and/or generate power from the generator(s) based on programmed parameters,
after the power has been provided based said parameters determining whether the operation is complete,
if the system operation is determined to be complete, returning to said obtaining of said time of day and said following steps,
if said system operation is determined not to be complete repeating said discharging/generating power, until the discharge is determined to be complete.

11. Method according to claim 9, wherein said method according to claim 9 comprises:
if it has been determined that the battery energy storage device is sufficiently charged,
determine the power load taken from the electric grid,
determining if the power load taken from the electric grid is not at or in excess of a predetermined threshold at which the battery energy storage system is directed to discharge energy,
if said power load taken from the electric grid is not at or in excess said predetermined threshold putting said battery energy storage system inverter/charger into standby mode,
if said power load taken from the electric grid is at or in excess of said predetermined threshold, discharge energy from the battery energy storage system according to determined discharge parameters,
after the discharge has been concluded, return to said determining step whether the battery energy storage system is still sufficiently charged with energy.

12. Computer program product comprising computer readable instructions stored on a computer readable medium for causing a computer to perform method steps, when said computer readable instructions are executed on a computer or a computerized power management system, comprising:
program code for determining a level of power available from generator with or without battery energy storage system,
program code for determining whether or not said generator with or without battery energy storage system is sufficiently able to provide power,
program code for obtaining a time of day, to be determined, and
program code for putting the generator into standby mode,
program code for charging the battery energy storage system at a previously determined duration and rate of charge, and
program code for evaluating whether said charging is completed,
program code for returning to said obtaining of time step,
program code for obtaining the day of the week, and
program code for determining if said obtained day of the week is Sunday or Saturday,
program code for resetting and putting the generator into Standby mode, and
program code for float charging said battery energy storage system and returning to said obtaining of the day or the week and said following steps, and
program code for monitoring real time demand, and
program code for obtaining said generator status and battery energy storage charge or discharge values, and
program code for communicating said generator status and battery energy storage charge or discharge values to power management system, and
program code for controlling release and/or charge from/into said generator with or without battery energy storage, and
program code for determining end of operation/charge and/or discharge of the generator with or without battery energy storage, and
program code of setting or determining demand value or operation/discharge set points, and
program code for communicating data regarding the power management system, and
program code for logging diagnostic information regarding the power management system.
